(19) United States
(12) Patent Application Publication
(10) Pub. No.: US 2002/0104485 A1
(43) Pub. Date: Aug. 8, 2002

(54) Method and apparatus for dispensing a liquid like gel or the like which may be used to treat dehydration in animals such as chicks and which may be used to carry other biological substances, for example, vaccines, nutrients, antibiotics and the like for other treatment purposes

(75) Inventors: Jason T. Lewis, New Braunfels, TX (US); Dennus Fitzsimmons, Cross Plains, WI (US); Bruce Grill, Middleton, WI (US); Steve Roudebush, Middleton, WI (US)

Correspondence Address: Michael Best & Friedrich LLP, 100 East Wisconsin Avenue, Milwaukee, WI, 53202-4108, US

(73) Assignee: MS BioScience, Madison, WI (US)

(21) Appl. No.: 10/015,111

(22) Filed: Dec. 11, 2001

Related U.S. Application Data
(60) Provisional application No. 60/254,670, filed on Dec. 11, 2000.

(51) Int. Cl. A01K 7/00; A01K 29/00

(52) U.S. Cl. 119/72.5; 119/651

(57) ABSTRACT

A dispensing device which controls a rate and an amount of discharge of a substance which may be used to treat animals for any number of reasons. The dispensing device has a tank including a top, a bottom and a cover. A movable piston is positioned within the tank, and the movable piston separates the tank into an upper chamber being above the movable piston and a lower chamber being below the movable piston. The dispensing device also includes a dispenser in fluid communication with the tank, and a dispensing head in fluid communication with the dispenser. The dispensing head further includes a plurality of apertures near an outer diameter of the dispensing head.

### CROSS-REFERENCE TO RELATED APPLICATIONS

This application claims priority to provisional patent application serial no. 60/254,670, filed on Dec. 11, 2000.

### BACKGROUND OF THE INVENTION

The present invention relates to methods and apparatuses which are used to dispense various substances, such as biological substances, to animals, such as chicks, for various treatment purposes. More specifically, the present invention relates to a method and apparatus which dispenses a gel like substance to treat dehydration in chicks.

It should be noted that although the present invention is primarily described in connection with dispensing a gel like substance to treat dehydration in chicks, the present invention is capable of dispensing other substances for other treatment purposes.

As is generally known, poultry hatchlings require immunization against various diseases within the first few days after birth. As is also generally known, dehydration can result from pathogens, unhealthy nutritional factors, unsanitary environmental conditions, and/or physiological disorders. It is commonly known to dispense vaccines, absorbent polymers and/or other aqueous suspensions over the top of the feed contained within a brooding tray or feeding tray holding the hatchlings in order to vaccinate the chicks or attempt to prevent the onset of dehydration in the chicks. Other methods may be employed, such as adding appropriate substances to the drinking water.

### SUMMARY OF THE INVENTION

One problem with the use of on-feed spray administration while chicks are feeding from a tray is that on-feed spray administration generally requires large doses of the chosen substance and uniform exposure of the flocks to the substance, such as a vaccine, cannot always be achieved.

Another problem with the use of on-feed spray administration while chicks are feeding from a tray is that it is difficult to control the rate at which the substance is applied and the amount of the substance that is applied.

Yet another problem with the use of on-feed spray administration while chicks are feeding from a tray concerns providing the substance to thousands of chicks in an efficient and timely fashion.

Accordingly, there is a need to provide a new method and apparatus to dispense a substance for treatment purposes, such as for treating dehydration in animals, such as chicks, which address the above noted problems and other problems.

The present invention provides a dispensing device which controls a rate and an amount of discharge of a substance which may be used to treat animals for any number of reasons. In one embodiment, the dispensing device has a tank including a top, a bottom and a cover. A movable piston is positioned within the tank, and the movable piston separates the tank into an upper chamber being above the movable piston and a lower chamber being below the movable piston. The dispensing device also includes a dispenser in fluid communication with the tank, and a dispensing head in fluid communication with the dispenser. The dispensing head further includes a plurality of apertures near an outer diameter of the dispensing head.

In one embodiment, the invention provides a dispensing device particularly suited to dispense a liquid like gel, although other substances can be dispensed, to a predetermined number of chicks. In a preferred embodiment, the gel is used to treat dehydration in animals, particularly chicks. One type of gel suitable for use to treat dehydration in chicks is disclosed in a U.S. Patent Application filed on Jun. 15, 2000 in the names of Harris B. Wright and Jason T. Lewis and entitled “Method for Treating Dehydration and Composition Therefor”, which is incorporated herein by reference in its entirety. Another suitable gel for use to treat dehydration in chicks is sold under the trademark GroGel™ by MS BioScience of Madison, Wis. It should be understood that other gels and/or substances may be used according to the principles of the present invention.

According to one method of the present invention for dispensing the liquid like gel to the chicks, a tray holding a predetermined number of chicks is placed under or below a nozzle of the dispensing head of the dispensing device. The gel dispensing machine or device dispenses the liquid gel. Activation of the gel dispensing machine causes a certain amount of gel to be dispensed out of the nozzle through a plurality of apertures in the dispensing head at a certain discharge rate. The gel is sprayed over the top of the chicks in a uniform fashion to better ensure uniform distribution of the gel. The gel dispensing machine according to the present invention is fully automated, thereby providing an easy to use device which efficiently delivers various substances to a predetermined number of animals.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a side elevational view, partially cut-away, illustrating a dispensing machine according to the present invention.

FIG. 2 is a cross-sectional view of a dispensing assembly of the dispensing machine of FIG. 1.

FIG. 3 is an enlarged cross-sectional view of a portion of the dispensing assembly of FIG. 2.

FIG. 4 is an exploded, perspective view of a nozzle of the dispensing assembly of FIG. 3.

FIG. 5 is a top view illustrating another dispensing machine according to the present invention.

Before the embodiments of the invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof herein is meant to encompass the items listed thereafter and equivalents thereof as well as additional items and equivalents thereof.

### DETAILED DESCRIPTION OF THE PREFERRED EMBODIMENTS

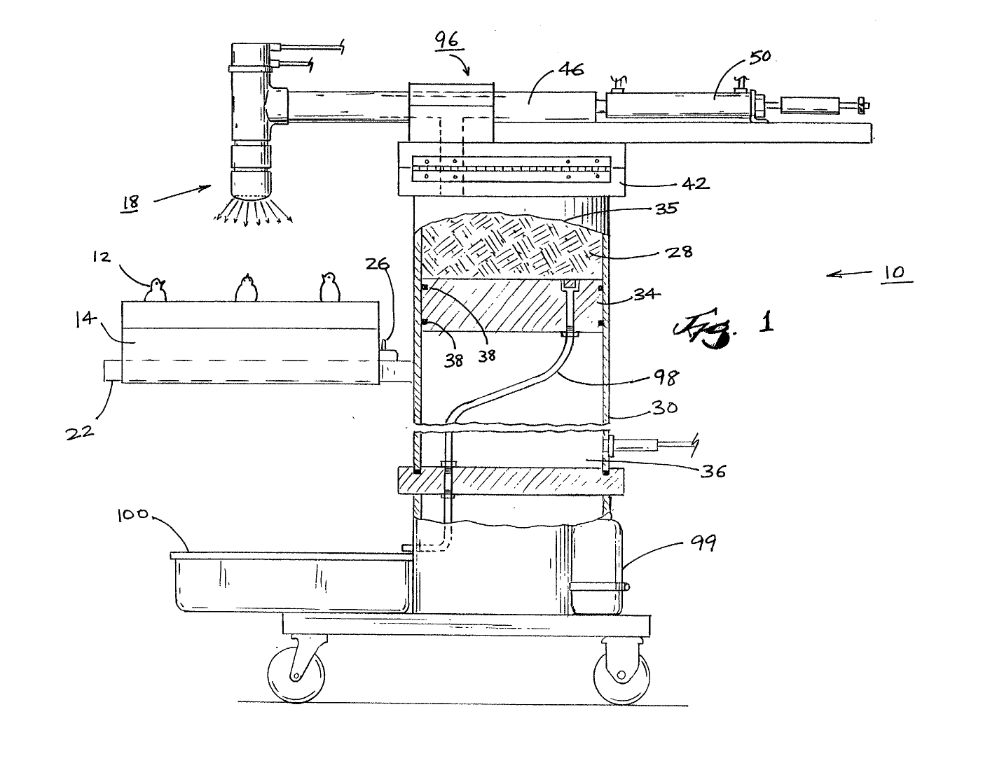

Illustrated in FIG. 1 is a dispensing machine 10 embodying the invention. It should be understood that although the various features of the present invention are described in relation to a gel dispensing machine for treating dehydration in chicks, the dispensing machine and methods of operation associated therewith are capable of use in other applications for other purposes. A description of the dispensing machine 10 and its manner of operation is provided below.

A predetermined number of chicks 12 are placed in a tray 14 below a dispensing head or a nozzle 18 of the dispensing machine 10. The tray 14 may be placed on a table 22 which moves in and out by activation of an actuator switch 26. Alternatively, the tray 14 may be supported by a conveyor assembly (not shown) that can be configured to hold a plurality of trays for efficient assembly operation. The actuator switch 26 enables easy placement and removal of the tray 14. A quantity of liquid like substance or gel 28 is contained within the tank 30, preferably a pressure vessel, of the dispensing machine 10. A movable piston 34 is positioned within the tank 30 beneath the gel 28. The movable piston 34 separates the tank 30 into an upper chamber 35, which is above the movable piston 34, and an lower chamber 36, which is below the movable piston 34. The inside wall of the tank 30 and the outer surface of the movable piston 34 provide an interference fit to prevent the gel from leaking below the movable piston 34. A pair of o-ring seals 38 may be provided to enhance the sealing relationship between the piston 34 and the inner wall of the tank 30. Preferably, the movable piston 34 moves upward under the force of air pressure supplied to the lower chamber 36 of the tank 30.

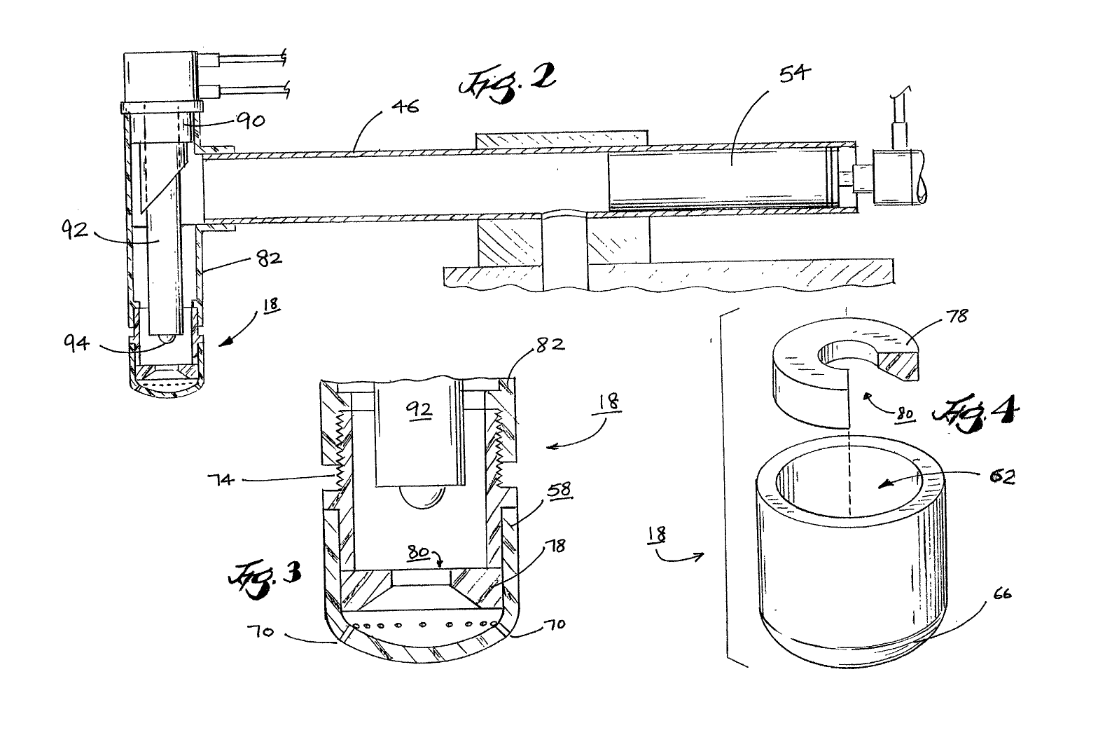

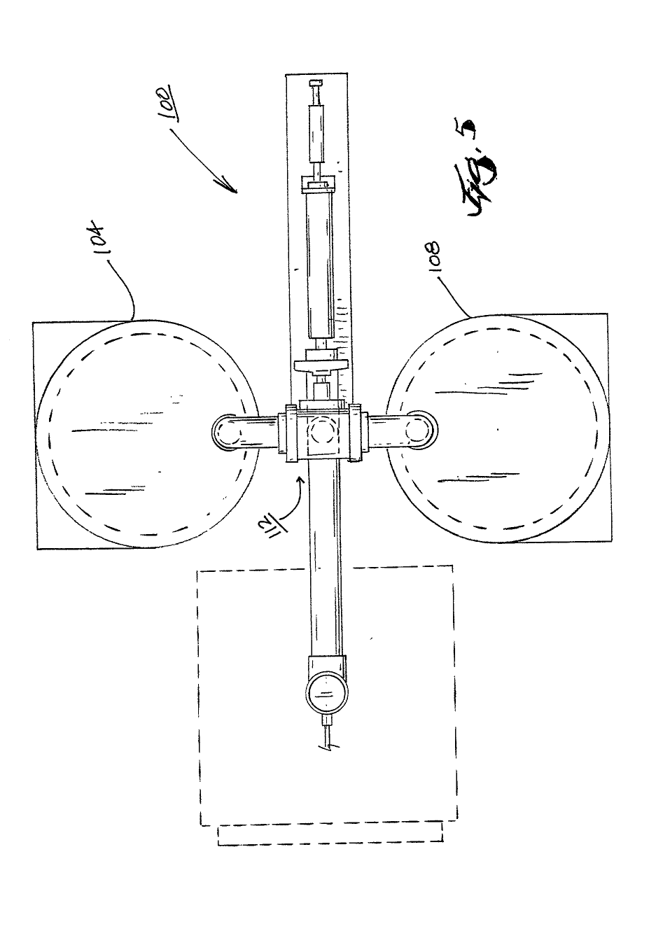

A hinged cover 42 is provided at the top of the tank 30 to allow access to the upper chamber 35 of the tank 30. A dispenser or T-shaped tube or line 46 extends between the nozzle 18 and the inner portion of the tank 30. An actuator 50 having a reciprocating piston 54 (FIG. 2) is positioned at one end of the tube 46. The actuator 50 is preferably a linear actuator which is hydraulically controlled, although other devices are suitable for use according to the teachings of the present invention. However, before the general operation and function are explained, reference is made to FIGS. 3-4 illustrating the nozzle 18 in greater detail.

The nozzle 18 includes an outer housing 58 having an open end 62 and a generally closed end 66 which includes a plurality of apertures 70 extending through the end 66. Preferably, there are thirty-six apertures positioned near the outer diameter of the end 66, and the apertures 70 are equally spaced apart from each other. The apertures 70 preferably have a 0.125 inch diameter and they are located 40° off center of a central axis extending through the housing 58. The number of apertures, the shape of the apertures and the location of the apertures are relevant in setting the rate and amount of discharge of the gel 28 from the dispensing machine 10. The nozzle 18 further includes a threaded connector portion 74 which mates with the housing 58. A stop plug 78 fits within the housing 58 and is positioned beneath the threaded connector portion 74. The stop plug 78 includes a hole 80 extending therethrough. The stop plug 78 may be glued within the housing 58. The connector portion 74 may also be glued to the housing 58. Once assembled, the nozzle 18 is threadably attached to a connecting tube 82 which is in fluid communication with the T-tube 46. Within the connecting tube 82, is an actuator or hydraulic cylinder 90 having a first piston 92 with a first piston end or a bulbous or rounded end 94. With the nozzle 18 components being identified, the operation of the dispensing machine 10 can now be explained.

To ready the dispenser 10 for operation, the cover 42 is closed and the various operating valves are set to their respective preparation positions. A main valve (not shown) is activated to supply air to the dispenser machine 10. As the tank 30 begins to pressurize, preferably in the upper chamber 35, the movable piston 34 will be lowered. Once air ceases to exhaust from the tank 30, the movable piston 34 has reached the bottom of the tank 30 and the main valve that supplies air to the dispenser machine 10 is turned off. Pressure from the upper chamber 35 is vented by opening an exhaust valve (not shown) provided on the cover 42. Thereafter, the cover 42 can be opened so that the substance or the gel 28 can be placed within the upper chamber 35. After the gel 28 is placed within the upper chamber 35, and the cover 42 is closed, the appropriate valves are set to their respective load positions. The main valve is turned on to supply air to the lower chamber 36 to load the gel 28 into position for dispensing. As the movable piston 34 rises, air will be forced out of the exhaust valve on the cover 42. Once the gel 28 begins to appear in the dispenser or the line 46, the appropriate valves are moved to their respective run positions. It should be noted that the tank 30 should be depressurized and the main valve shut off before attempting to open the cover 42. Once the gel 28 is at the top of the tank 20, a dispensing trigger (not shown) is activated to remove all of the remaining air from the dispenser machine 10 and to prime the dispensing head 96 with the gel 28.

To prevent the gel 28 from being dispensed out of the nozzle 18, the actuator 90 causes the first piston 92 to move downward until the first piston end 94 of the piston 92 seats within hole 80 of the stop plug 78. In this way, until the first piston 92 is moved upward, no gel 28 can leak out of the nozzle 18.

Once the gel 28 is properly positioned in the dispenser 46 and the connecting tube 82 to basically fill the area between the nozzle 18 and the tank 30, the dispensing trigger is activated so that the first piston 92 moves upward, thereby allowing access to the hole 80, and the actuator 50 causes the reciprocating piston 54 to move in a direction to push the gel 28 out of the nozzle 18. The actuators 50 and 90 are set to operate in such a way that only a predetermined amount of gel, e.g., one hundred grams, is dispensed with each activation of the trigger. The cooperation between the end 94 and the hole 80 of the stop plug 78 prevent leaking of the gel 28 when it is not desired to dispense the gel 28. The location of the apertures 70 ensure that the gel is evenly distributed over the tops of the chicks. This can be repeated until the tank 30 is empty.

After dispensing all gel 28, a water hose (not shown) can be used to clean the tank 30. Cleaning solution can be sent from a soap jar 99 through the dispenser 46 by operating the valves in an appropriate manner. The dispensing trigger can be actuated repeatedly until only clean water comes out of the dispensing head or the nozzle 18. A spray gun (not shown) can be used to thoroughly clean the tank 30 inside and out. A drain line 98 allows the water and solution to drain out of the tank 30 into a catch tray 100.

Of course, certain components may be replaced with other components, and the manner of operation of the dispensing machine 10 may be modified to accommodate use of such other components.

FIG. 5 shows a second embodiment of a dispensing machine 100 wherein two tanks, a first tank 104 and a second tank 108 are provided. In this arrangement, as the first tank 104 is being emptied, the second tank 108 can be filled. The piping and head assembly 112 is adapted for such an operation. Preferably, the second tank 108 is filled the same substance as the tank 104. In yet another embodiment, the first tank 104 and the second tank 108 are filled with different substances.

Although certain components and methods of operation have been described, variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A method of dispensing a substance over a number of animals, the method comprising:
placing a number of animals in a tray configured to be passed below a dispensing head, the dispensing head being in fluid communication with a dispenser and having a plurality of apertures, and the dispenser being in fluid communication with a tank, and the tank including a top, a bottom and a cover, and having positioned within the tank a movable piston separating the tank into an upper chamber being above the movable piston and a lower chamber being below the movable piston;
pressurizing the upper chamber, thereby lowering the movable piston until the movable piston substantially reaches the bottom;
placing the substance within the upper chamber;
pressurizing the lower chamber, thereby lifting the movable piston and forcing the substance into the dispenser and into the dispensing head; and
activating a dispensing trigger, thereby forcing the substance out of the apertures.

2. The method of claim 1, wherein pressurizing the upper chamber further comprises:
activating a main valve to the dispenser before pressurizing the tank;
deactivating the main valve to the dispenser after the movable piston substantially reaches the bottom; and
opening an exhaust valve in the cover to vent the upper chamber.

3. The method of claim 1, further comprising adjusting an amount of substance to be dispensed with an activation of the dispensing trigger.

4. The method of claim 1, further comprising actuating a dispensing head actuator in the dispensing head thereby moving a first piston downwardly until a first piston end seats within a stop plug.

5. The method of claim 1, further comprising sealing the movable piston with an o-ring.

6. The method of claim 1, further comprising positioning the apertures near an outer diameter of the dispensing head.

7. The method of claim 6, further comprising:
positioning the apertures to be equally spaced apart from each other; and
positioning the apertures at substantially 40° off center of a central axis extending through the dispensing head.

8. The method of claim 1, wherein the tank is a first tank, further comprising providing a second tank, and the second tank being in fluid communication with the dispenser.

9. The method of claim 8, wherein the substance is a first substance, further comprising filling the second tank with a second substance.

10. The method of claim 8, further comprising filling the second tank with the substance.

11. The method of claim 1, further comprising passing the tray on a conveyor below the dispensing head.

12. An apparatus for dispensing substance over a number of animals, the apparatus comprising:
a tank including a top, a bottom and a cover, and having positioned within the tank a movable piston separating the tank into an upper chamber being above the movable piston and a lower chamber being below the movable piston, the upper chamber being pressurized thereby lowering the movable piston until the movable piston substantially reaches the bottom, the upper chamber being filled with a substance, and the lower chamber being pressurized thereby lifting the movable piston and the substance to the top;
a dispenser in fluid communication with the tank, the dispenser being filled with the substance when the movable piston is moved toward the top; and
a dispensing head in fluid communication with the dispenser.

13. The apparatus of claim 12, further comprising a dispensing head actuator being actuated in the dispenser thereby moving a first piston downwardly until a first piston end seats within a stop plug.

14. The apparatus of claim 12, wherein the dispensing head further comprises a plurality of apertures near an outer diameter of the dispensing head.

15. The apparatus of claim 14, wherein the apertures are equally spaced apart and are positioned at substantially 40° off center of a central axis extending through the dispensing head.

16. The apparatus of claim 12, wherein the tank is a first tank, further comprising a second tank, and the second tank being in fluid communication with the dispenser.

17. The apparatus of claim 16, wherein the substance is a first substance, and the second tank is filled with a second substance.

18. The apparatus of claim 16, wherein the second tank is filled with the substance.

19. The apparatus of claim 12, further comprising a tray, and the tray being configured to be positioned below the dispensing head.

20. The apparatus of claim 19, further comprising a conveyor supporting the tray below the dispensing head.

21. An apparatus for dispensing substance over a number of animals, the apparatus comprising:
a tank including a top, a bottom and a cover, and having positioned within the tank a movable piston separating the tank into an upper chamber being above the movable piston and a lower chamber being below the movable piston, the upper chamber being pressurized thereby lowering the movable piston until the movable piston substantially reaches the bottom, the upper chamber being filled with a substance, and the lower chamber being pressurized thereby lifting the movable piston and the substance to the top;
a dispenser in fluid communication with the tank, the dispenser being filled with the substance when the movable piston is moved toward the top; and
a dispensing head in fluid communication with the dispenser, and the dispensing head having a plurality of apertures near an outer diameter of the dispensing head.

22. The apparatus of claim 21, further comprising a dispensing head actuator being actuated in the dispenser thereby moving a first piston downwardly until a first piston end seats within a stop plug.

23. The apparatus of claim 21, wherein the apertures are equally spaced apart and are positioned at substantially 40° off center of a central axis extending through the dispensing head.

24. The apparatus of claim 21, wherein the tank is a first tank, further comprising a second tank, and the second tank being in fluid communication with the dispenser.

25. The apparatus of claim 24, wherein the substance is a first substance, and the second tank is filled with a second substance.

26. The apparatus of claim 24, wherein the second tank is filled with the substance.

27. The apparatus of claim 21, further comprising a tray, and the tray being configured to be positioned below the dispensing head.

28. The apparatus of claim 27, further comprising a conveyor supporting the tray below the dispensing head.
